(19) United States
(12) Patent Application Publication
(10) Pub. No.: US 2026/0237982 A1
(43) Pub. Date: Aug. 13, 2026

(54) ELECTRIC POWER DEVICE, AND DEVICE FOR MOVING CIRCUIT BREAKER FOR ELECTRIC POWER DEVICE

(71) Applicant: LS ELECTRIC CO., LTD., Anyang-si, Gyeonggi-do (KR)

(72) Inventors: Ki Hyeon KIM, Anyang-si, Gyeonggi-do (KR); Min Kyu SEO, Anyang-si, Gyeonggi-do (KR)

(21) Appl. No.: 19/155,718

(22) PCT Filed: Feb. 27, 2024
(86) PCT No.: PCT/KR2024/002530

§ 371 Date: Aug. 12, 2025

(30) Foreign Application Priority Data
Apr. 14, 2023 (KR) 10-2023-0049251

(51) Int. Cl. H02B 11/127; G01C 3/02; H02B 11/167

(52) U.S. Cl. CPC H02B 11/127; G01C 3/02; H02B 11/167

(57) ABSTRACT

Provided is a device for moving a circuit breaker for an electric power device. A device for moving a circuit breaker for an electric power device, according to one aspect of the present disclosure, may comprise: an actuator for generating driving force to move a circuit breaker disposed inside a cradle of the electric power device; a support frame that can be removably coupled to the outer portion of the cradle to support the actuator; a distance-measuring sensor provided on one side of the support frame to measure the distance from the circuit breaker; and a controller configured to control the actuator on the basis of information obtained by the distance-measuring sensor.

### CROSS-REFERENCE TO RELATED APPLICATION

This application is the national phase entry of International Application No. PCT/KR2024/002530, filed on Feb. 27, 2024, which is based upon and claims priority to Korean Patent Application No. 10-2023-0049251, filed on Apr. 14, 2023, the entire contents of which are incorporated herein by reference.

### FIELD

The present disclosure relates to a power apparatus and a device for moving a circuit breaker for the power apparatus, and more particularly, to a power apparatus including a circuit breaker and a device for moving the circuit breaker for the power apparatus.

### BACKGROUND

In general, a power apparatus refers to any device capable of receiving, transmitting, or converting electric power. Such a power apparatus may include a cradle and a circuit breaker accommodated inside the cradle.

The circuit breaker is installed in a power distribution line to perform operations such as power transmission and reception, switching, and stopping of a power system in a planned manner, and to protect human life and peripheral equipment by interrupting the circuit when an abnormal current occurs, and the cradle is configured to accommodate the circuit breaker inside it and to perform a function of isolating and protecting the circuit breaker from the outside.

The power apparatus may be additionally provided with a configuration such as a truck for pulling the circuit breaker out of or into the cradle for maintenance or replacement. Accordingly, the circuit breaker may be drawn into or out of the cradle. After being pulled out of the cradle for maintenance or replacement, the circuit breaker may be reinserted into the cradle to perform its original function.

In recent years, power apparatuses have been developed that can automatically draw a circuit breaker into or pull it out of a cradle using a motor, for improved user safety and convenience.

The conventional power apparatus is configured to detect the position of the circuit breaker and control the motor by placing a switch on the moving path of the circuit breaker that may be pressed by the circuit breaker, and using a signal obtained from the switch pressed by the moving circuit breaker.

However, in the conventional power apparatus, the number of switches and the installation points required may vary depending on the model, and since additional space and wiring are required for installing the switches, there is a problem in that the design flexibility and space utilization inside the power apparatus are limited.

In addition, in the conventional power apparatus, an operation error of the switch may occur due to a clearance between configurations or a backlash phenomenon during the drawing into or out of the circuit breaker, making it difficult to accurately detect the position of the circuit breaker.

Furthermore, in the conventional power apparatus, the switch is configured to be repeatedly and strongly pressed by the circuit breaker or a configuration transferred together with the circuit breaker, which may easily cause damage due to physical contact, thereby reducing the durability of the apparatus.

### SUMMARY

The present disclosure has been made in view of the above, and an object of the present disclosure is to provide a power apparatus and a circuit breaker moving device for the power apparatus, which are capable of automatically moving a circuit breaker.

Another object of the present disclosure is to provide a power apparatus and a circuit breaker moving device for the power apparatus, which are capable of accurately detecting a position of a circuit breaker.

Yet another object of the present disclosure is to provide a power apparatus and a circuit breaker moving device for the power apparatus, which are capable of accurately controlling a position of a circuit breaker.

Still another object of the present disclosure is to provide a power apparatus and a circuit breaker moving device for the power apparatus, which are capable of detecting a position of a circuit breaker while increasing design flexibility and utilization of internal space.

An additional another object of the present disclosure is to provide a power apparatus and a circuit breaker moving device for the power apparatus, which are capable of detecting a position of a circuit breaker while ensuring high durability.

The problems of the present disclosure are not limited to those mentioned above, and other problems not mentioned will be clearly understood by those of ordinary skill in the art from the following description.

According to an aspect of the present disclosure, there is provided a device for moving circuit breaker for a power apparatus including: an actuator configured to generate a driving force for moving a circuit breaker disposed inside a cradle of a power apparatus; a support frame configured to support the actuator and to be detachably coupled to an outer portion of the cradle; a distance measuring sensor provided on one side of the support frame and configured to measure a distance to the circuit breaker; and a controller configured to control the actuator based on information acquired by the distance measuring sensor.

In this case, the support frame may include a sensor support configured to support the distance measuring sensor; an extension portion configured to extend from the sensor support to protect one side of the distance measuring sensor; and a coupler provided on one side of the extension portion and configured to detachably couple the support frame to an outer side of the cradle.

In this case, The circuit breaker moving device includes a guide rod configured to extend outward from the support frame; and an adjustment frame configured to be movably coupled to the guide rod, the actuator may be fixedly coupled to the adjustment frame.

In this case, the adjustment frame may be provided with a coupling member configured to fix or release a relative position between the adjustment frame and the guide rod.

In this case, a guide groove may be formed along an extending direction on an outer circumferential portion of the guide rod, and one side of the adjustment frame may be slidably inserted into the guide groove.

In this case, the actuator may be provided with a driving shaft, the driving shaft being extended outward from one side of the actuator to transmit the driving force into the cradle.

In this case, a hole may be formed in the support frame, and one side of the driving shaft may be inserted into the hole formed in the support frame so as to be rotatably supported by the support frame.

In this case, the support frame may include a sensor support having the distance measuring sensor supported on one side thereof; a first extension portion configured to obliquely extend from one side of the sensor support to protect one side of the distance measuring sensor; and a second extension portion configured to obliquely extend from the other side of the sensor support to protect the other side of the distance measuring sensor.

In this case, the distance measuring sensor may be a laser distance sensor configured to measure a distance using a laser emitted toward the circuit breaker.

According to another aspect of the present disclosure, there is provided a power apparatus including a cradle configured to have a housing shape and to include a cradle terminal on an inner wall thereof; a transfer frame movably provided on one side of the cradle; a circuit breaker supported by the transfer frame and configured to be moved to a connection position where the circuit breaker is mechanically and electrically connected to the cradle terminal or to a separation position where the circuit breaker is separated from the cradle terminal; an actuator configured to provide a driving force for moving the transfer frame such that the circuit breaker is moved to the connection position or the separation position; a distance measuring sensor disposed apart from the circuit breaker and configured to measure a distance to the circuit breaker; and a controller configured to control the actuator based on information acquired by the distance measuring sensor.

In this case, the distance measuring sensor may be disposed to face the cradle terminal with the circuit breaker interposed therebetween.

In this case, the cradle may include a first side wall on which the cradle terminal is installed and a second side wall facing the first side wall, wherein the distance measuring sensor may be disposed outside the second side wall, and the second side wall of the cradle may be provided with a window configured to allow the distance measuring sensor to view the circuit breaker disposed inside the cradle.

In this case, the power apparatus may include a support frame provided on an outer surface of the second side wall, the actuator may be coupled to one side of the support frame, and the distance measuring sensor may be installed on the other side of the support frame.

In this case, the power apparatus may include a driven shaft disposed adjacent to one surface of the transfer frame to move the transfer frame as it rotates by an external force; and a driving shaft having one side coupled to the driven shaft and the other side configured to receive the driving force generated by the actuator, the driving shaft may penetrate the outer surface of the cradle.

In this case, the support frame may be detachably coupled to the outer surface of the second side wall.

In this case, the power apparatus may include a guide rod configured to extend from the support frame in a direction away from the cradle; and an adjustment frame configured to be slidably coupled to the guide rod, wherein the actuator may be coupled to the adjustment frame such that a distance spaced apart from the cradle may be adjusted.

In this case, the adjustment frame may be provided with a coupling member configured to fix or release a relative position between the adjustment frame and the guide rod.

In this case, a guide groove may be formed along an extending direction on an outer circumferential portion of the guide rod, and one side of the adjustment frame may be slidably inserted into the guide groove.

In this case, one side wall of the cradle may be formed as a door that is openable and closable to allow the circuit breaker to enter and exit.

In this case, the distance measuring sensor may be disposed on one surface of the door.

In this case, the distance measuring sensor may be disposed to be spaced apart from the circuit breaker in a direction parallel to a moving direction of the circuit breaker.

In this case, the distance measuring sensor may be a laser distance sensor configured to measure a distance using a laser emitted toward the circuit breaker.

In the power apparatus and the circuit breaker moving device for the power apparatus according to an embodiment of the present disclosure, since the actuator generates a driving force for moving the circuit breaker inside the cradle, the circuit breaker may be automatically moved.

In the power apparatus and the circuit breaker moving device for the power apparatus according to an embodiment of the present disclosure, the distance measuring sensor disposed apart from the circuit breaker is configured to measure a distance to the circuit breaker, and the controller is configured to detect the position of the circuit breaker based on the distance information, so that the position of the circuit breaker may be continuously and accurately detected.

In the power apparatus and the circuit breaker moving device for the power apparatus according to an embodiment of the present disclosure, the distance measuring sensor disposed apart from the circuit breaker is configured to measure a distance to the circuit breaker, and the controller is configured to detect the position of the circuit breaker based on the distance information and to control the actuator based on the detected position, so that the position of the circuit breaker may be continuously and accurately controlled.

In the power apparatus and the circuit breaker moving device for the power apparatus according to an embodiment of the present disclosure, the distance measuring sensor disposed apart from the circuit breaker is configured to measure a distance to the circuit breaker in a non-contact manner, and the controller is configured to detect the position of the circuit breaker based on the measured distance, and thus there is no need to provide a separate contact-type switch inside the power apparatus, which may increase the design flexibility and internal space utilization of the power apparatus.

In the power apparatus according to an embodiment of the present disclosure, the distance measuring sensor disposed apart from the circuit breaker measures a distance to the circuit breaker in a non-contact manner, and the controller detects the position of the circuit breaker based on the measured distance, and thus, there is no need to provide a separate contact-type switch inside the power apparatus, which may eliminate the possibility of damage due to physical contact and thereby improve the durability of the power apparatus.

Advantageous effects of embodiments of the present disclosure are not limited to the above-described effects, and other effects not mentioned will be clearly understood by those of ordinary skill in the art from the present specification and the accompanying drawings.

### BRIEF DESCRIPTION OF THE DRAWINGS

FIGS. 1 and 2 are top perspective views of a power apparatus according to an embodiment of the present disclosure. In this case, in FIG. 2, the configurations that are visually perceivable through the cradle and the circuit breaker are indicated by solid lines.

FIG. 3 is a side view of a power apparatus according to an embodiment of the present disclosure. In this case, the configurations that are visually perceivable through the cradle and the circuit breaker are indicated by solid lines.

FIG. 4 is a top exploded perspective view of a transfer module of a power apparatus according to an embodiment of the present disclosure.

FIG. 5 is an exploded perspective view of a cradle, a driving module, and a distance measuring sensor of a power apparatus according to an embodiment of the present disclosure.

FIGS. 6 and 7 are perspective views of the driving module and the distance measuring sensor of the power apparatus according to an embodiment of the present disclosure, viewed from different angles.

FIG. 8 is a view illustrating a state in which the circuit breaker of the power apparatus according to an embodiment of the present disclosure is positioned at a connection position. In this case, the configurations that are visually perceivable through the cradle are indicated by solid lines, and the driven shaft, the transfer member, and the distance measuring sensor are indicated by dotted lines.

FIG. 9 is a view illustrating a state in which the circuit breaker of the power apparatus according to an embodiment of the present disclosure moves from the connection position to a separation position. In this case, the configurations that are visually perceivable through the cradle are indicated by solid lines, and the driven shaft, the transfer member, and the distance measuring sensor are indicated by dotted lines.

FIG. 10 is a view illustrating a state in which the circuit breaker of the power apparatus according to an embodiment of the present disclosure is positioned at a separation position. In this case, the configurations that are visually perceivable through the cradle are indicated by solid lines, and the driven shaft, the transfer member, and the distance measuring sensor are indicated by dotted lines.

### DETAILED DESCRIPTION

Hereinafter, embodiments of the present disclosure will be described in detail with reference to the accompanying drawings so that those of ordinary skill in the art may readily implement the present disclosure. The present disclosure may be embodied in various forms and is not limited to the embodiments set forth herein. For clarity, parts not related to the description are omitted from the drawings, and like reference numerals refer to like or similar elements throughout the specification.

The words and terms used in the present specification and claims should not be construed as being limited to their ordinary or dictionary meanings, but should be interpreted in accordance with the principle that an inventor may define terms and concepts to best describe the invention, and should be understood as having meanings and concepts consistent with the technical spirit of the present disclosure.

In the present specification, terms such as “comprise,” “include,” or “have” are intended to indicate the presence of the stated features, numbers, steps, operations, components, parts, or combinations thereof, but should be understood as not precluding the possibility of the presence or addition of one or more other features, numbers, steps, operations, components, parts, or combinations thereof.

Unless otherwise specified, when one component is described as being at the “front,” “rear,” “upper,” or “lower” of another component, this includes not only a configuration in which it is directly positioned in the front, rear, upper, or lower side of the other component, but also a configuration in which another component is interposed between them. In addition, unless otherwise specified, when one component is described as being “connected” to another component, this includes both a direct connection and an indirect connection.

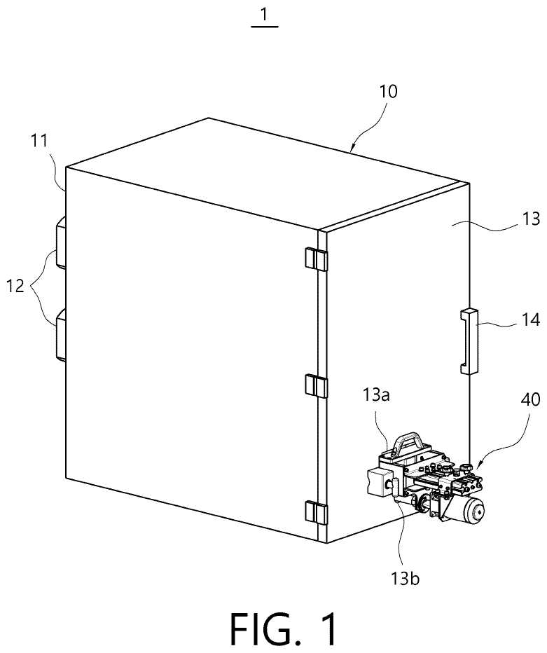

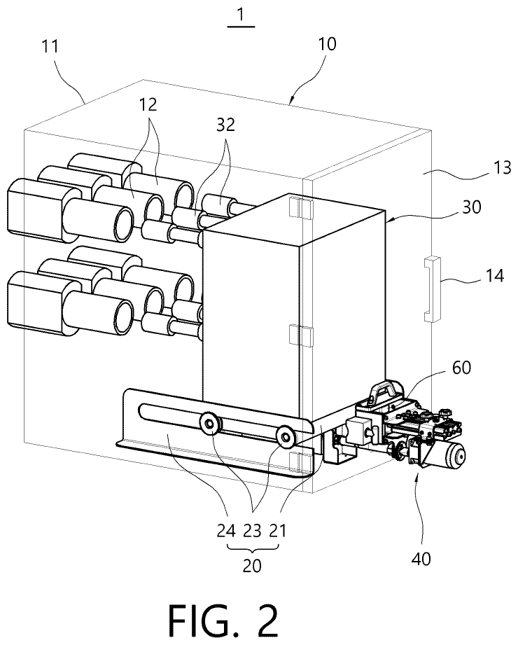

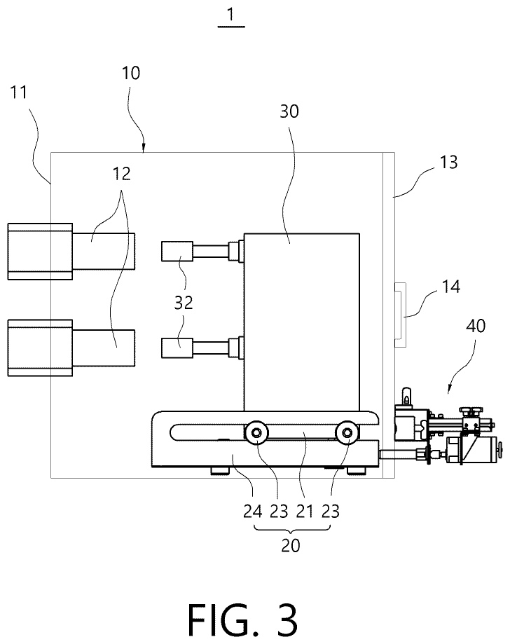

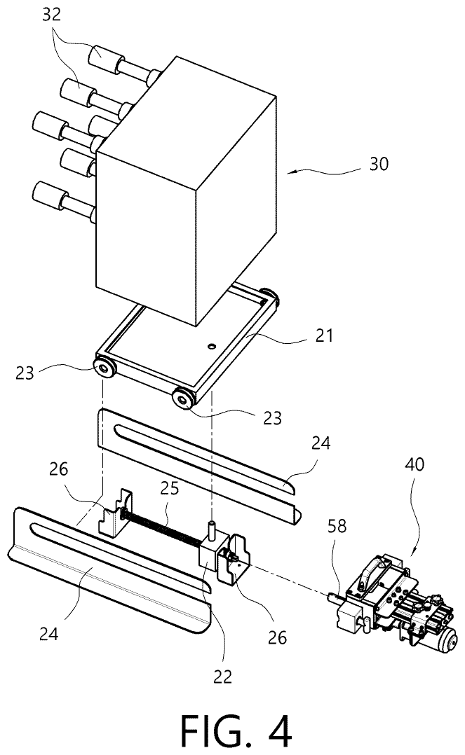

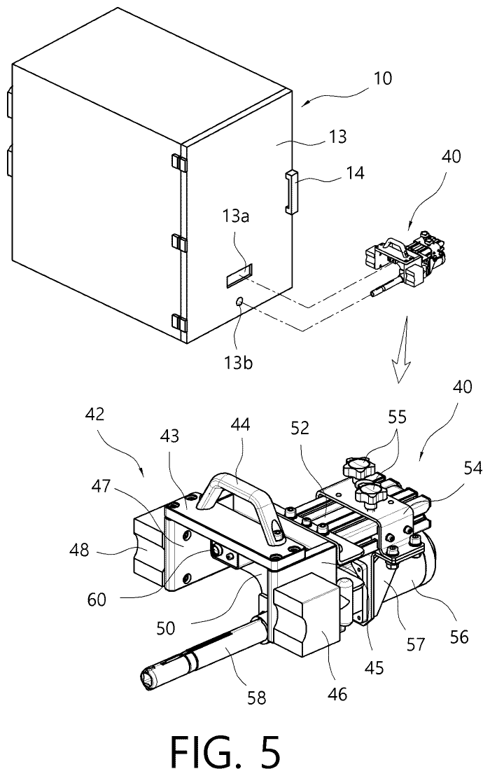

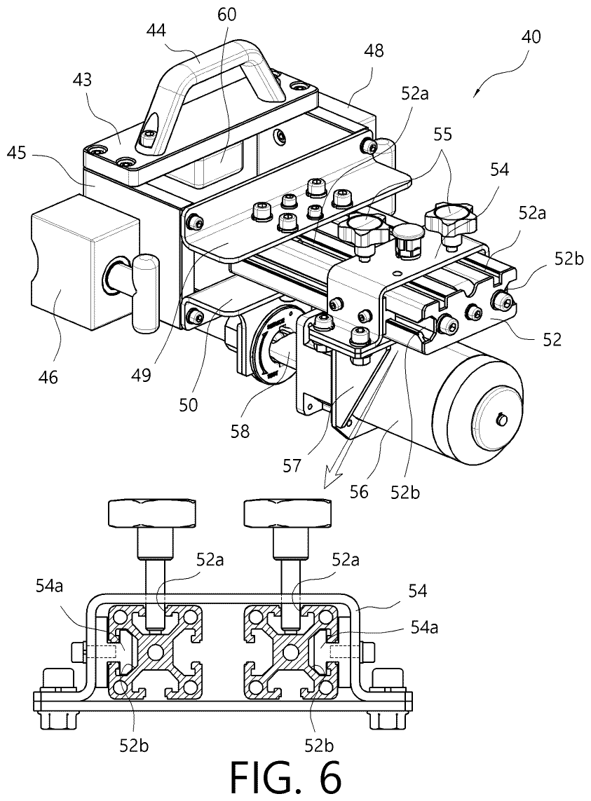

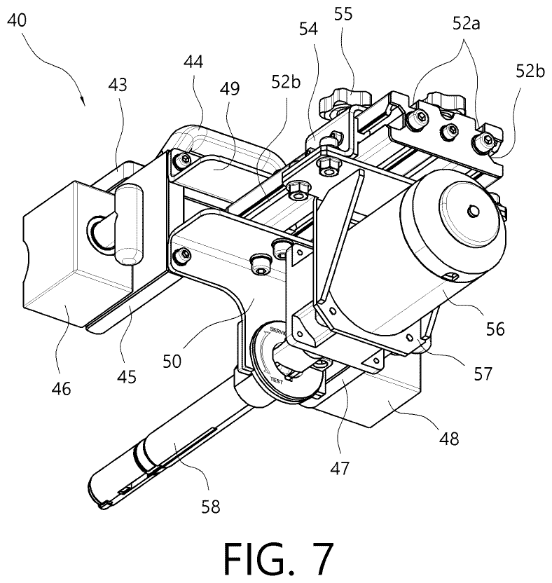

FIGS. 1 and 2 are top perspective views of a power apparatus according to an embodiment of the present disclosure. In this case, in FIG. 2, the configurations that are visually perceivable through the cradle and the circuit breaker are indicated by solid lines. FIG. 3 is a side view of a power apparatus according to an embodiment of the present disclosure. In this case, the configurations that are visually perceivable through the cradle and the circuit breaker are indicated by solid lines. FIG. 4 is a top exploded perspective view of a transfer module of a power apparatus according to an embodiment of the present disclosure. FIG. 5 is an exploded perspective view of a cradle, a driving module, and a distance measuring sensor of a power apparatus according to an embodiment of the present disclosure. FIGS. 6 and 7 are perspective views of the driving module and the distance measuring sensor of the power apparatus according to an embodiment of the present disclosure, viewed from different angles.

Hereinafter, in the description of the drawings, the left side in FIG. 1 is defined as the rear side, and the right side is defined as the front side.

Referring to FIGS. 1 to 3, a power apparatus 1 according to an embodiment of the present disclosure may include a cradle 10, a transfer module 20, a circuit breaker 30, a driving module 40, a distance measuring sensor 60, and a controller (not illustrated).

The power apparatus 1 according to an embodiment of the present disclosure is an electric power apparatus configured to accurately control the position of the circuit breaker 30 by detecting a position of the circuit breaker 30, which is movable inside the cradle 10 having a housing shape, and moving the circuit breaker 30 based on the detected position information.

Referring to FIGS. 1 to 3, the power apparatus 1 according to an embodiment of the present disclosure may constitute a part of a power system at a higher level than the present power apparatus 1, for example, a part of a distribution board.

In this case, the cradle 10 of the power apparatus 1 according to the present embodiment may have a housing shape as described above. As illustrated in FIGS. 2 and 3, a plurality of cradle terminals 12 through which distribution lines pass may be provided in a rear side wall 11 of the cradle 10. Hereinafter, the rear side wall 11 of the cradle 10 provided with the cradle terminals 12 is referred to as a terminal installation wall 11.

The plurality of cradle terminals 12 may include one set of three cradle terminals 12 arranged in a horizontal direction, and two such sets may be arranged in a vertical direction. In this case, a portion of each cradle terminal 12 may extend inward from an inner wall of the cradle 10. An opening into which a circuit breaker terminal 32, which will be described below, may be inserted may be formed at an end of each cradle terminal 12 in an extending direction.

Meanwhile, according to an embodiment of the present disclosure, a door 13 may be provided at a front portion of the cradle 10 facing the terminal installation wall 11. The door 13 may be configured to open and close to control access between the interior and the outside of the cradle 10.

As illustrated in FIGS. 1 and 2, in the present embodiment, the door 13 may be formed as a rectangular plate having a predetermined thickness. A left rim of the door 13 may be rotatably coupled to the cradle 10, and a right rim of the door 13 may be provided with an arch-shaped door handle 14 that a worker may grip.

The worker may grip the door handle 14 and rotate the door 13 to open the interior of the cradle 10. Then, the worker may take out the circuit breaker 30 disposed inside the opened cradle 10 to the outside and perform tasks such as maintenance or replacement.

In an embodiment of the present disclosure, the door 13 may include a window 13a configured to allow observation of the interior of the cradle 10 from the outside, and a shaft hole 13b through which a driving shaft 58 (illustrated in FIG. 5) of the driving module 40, which will be described below, may pass. The window 13a and the shaft hole 13b will be described below with reference to FIG. 5.

Meanwhile, the structure of the cradle 10 and the cradle terminal 12 may be variously modified, for example, by forming a portion thereof to be curved or opened as necessary, in consideration of characteristics of the power system, the type of the circuit breaker 30, and the location where the present power apparatus 1 is installed.

In addition, the relative positions of the door 13 and the cradle terminal 12 are not limited to the illustrated embodiment, and the door 13 may be provided at various positions, such as on other side walls or an upper wall of the cradle 10.

Moreover, the manner in which the door 13 opens and closes the interior of the cradle 10 is not limited to the illustrated rotating door type and may include various opening and closing structures known in the art, such as a sliding type.

Referring again to FIGS. 1 to 3, in an embodiment of the present disclosure, a circuit breaker 30 may be disposed inside the cradle 10. In the present embodiment, the circuit breaker 30 may be configured to be movable forward and backward within the cradle 10. In the present embodiment, the circuit breaker 30 may be movable in a direction toward the terminal installation wall 11 of the cradle 10 and in a direction away from the terminal installation wall 11. Of course, the moving direction of the circuit breaker 30 may be appropriately set as necessary.

The circuit breaker 30 may be an electrical device configured to perform power transmission and reception, switching, and stopping of a power system, and to interrupt a circuit when an abnormal current occurs. Since the circuit breaker 30 may be implemented in various well-known configurations, a detailed description thereof will be omitted.

In the present embodiment, the circuit breaker 30 may be configured as an overall hexahedral assembly, as illustrated. A plurality of circuit breaker terminals 32 protruding rearward may be provided on a surface of the circuit breaker 30 facing the terminal installation wall 11, that is, on a rear surface of the circuit breaker 30. The plurality of circuit breaker terminals 32 may include one set of three terminals arranged in the horizontal direction, and two such sets may be arranged in the vertical direction to correspond to the plurality of cradle terminals 12.

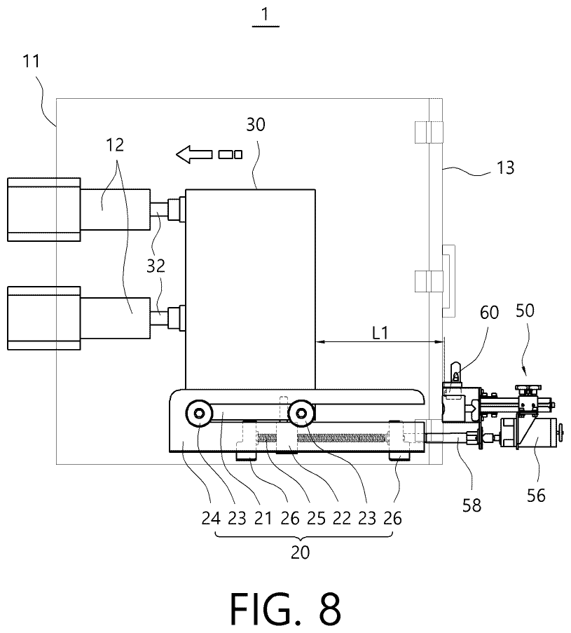

In this case, the circuit breaker 30 may be positioned adjacent to the terminal installation wall 11 (or the cradle terminal 12) of the cradle 10 such that the circuit breaker terminals 32 may be electrically and mechanically connected to the cradle terminals 12 (as illustrated in FIG. 8). Hereinafter, this position of the circuit breaker 30 is referred to as a connection position. The circuit breaker 30 located at the connection position may perform its original function as described above.

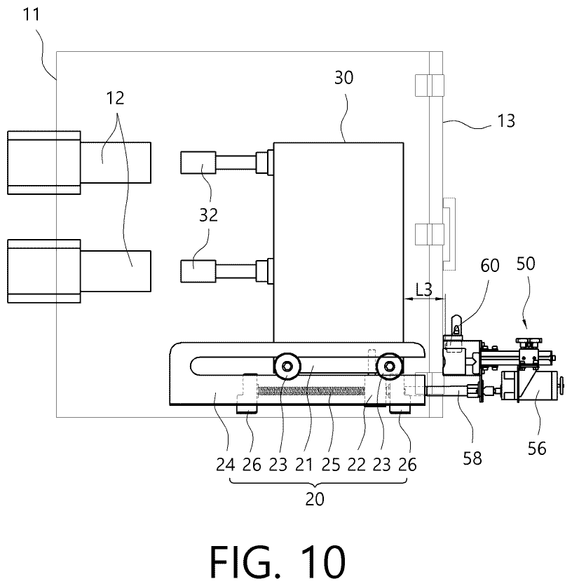

Alternatively, the circuit breaker 30 may be positioned apart from the terminal installation wall 11 (or the cradle terminal 12) of the cradle 10 such that the circuit breaker terminals 32 may be electrically and mechanically separated from the cradle terminals 12 (as illustrated in FIG. 10). Hereinafter, this position of the circuit breaker 30 is referred to as a separation position. The circuit breaker 30 located at the separation position may be electrically deactivated since it is separated from the cradle terminals 12. Accordingly, the worker may safely maintain or replace the electrically deactivated circuit breaker 30.

Meanwhile, referring to FIGS. 2 to 4, in the power apparatus 1 according to an embodiment of the present disclosure, a transfer module 20 may be provided at a lower side of the cradle 10 so that the circuit breaker 30 may be movable inside the cradle 10.

In the present embodiment, the transfer module 20 may include a transfer frame 21, a transfer member 22, a guide frame 24, a driven shaft 25, and a shaft frame 26.

According to an embodiment of the present disclosure, the transfer frame 21 may be formed as a rectangular plate extending in the horizontal direction, as illustrated in FIG. 4. Such a transfer frame 21 may be configured to support a lower portion of the circuit breaker 30. Of course, if necessary, the circuit breaker 30 may be coupled to the transfer frame 21 or may be integrally provided with the transfer frame 21.

In this case, in the present embodiment, the transfer frame 21 may be configured to be movable forward and backward at a lower portion of the cradle 10. For this purpose, as illustrated, a plurality of wheels 23 may be provided on both sides of the transfer frame 21. More specifically, the plurality of wheels 23 may be rotatably coupled to the front and rear portions of the left side and the front and rear portions of the right side of the transfer frame 21, respectively.

And, according to the present embodiment, in order to guide the plurality of wheels 23, a pair of guide frames 24 may be provided on both sides of the transfer frame 21. The guide frames 24 may extend along a moving direction of the transfer frame 21, that is, a front-rear direction. In this case, according to an embodiment of the present disclosure, a lower portion of each guide frame 24 may be fixed to a lower wall of the cradle 10. Accordingly, the guide frames 24 may stably guide the transfer frame 21.

Meanwhile, as illustrated in FIGS. 3 and 4, according to an embodiment of the present disclosure, each guide frame 24 may be formed with a predetermined guide hole extending in an extending direction, that is, the front-rear direction. In this case, the guide hole may be formed such that a front end is open toward the front. Accordingly, the circuit breaker 30 or the transfer frame 21, which will be described below, may be taken out to the front of the power apparatus 1.

A wheel 23 installed on the right side of the transfer frame 21 may be rollably coupled to the guide hole of the guide frame 24 provided on the right side of the transfer frame 21. Likewise, a wheel 23 installed on the left side of the transfer frame 21 may be rollably coupled to the guide hole of the guide frame 24 provided on the left side of the transfer frame 21.

Accordingly, the transfer frame 21 may support a lower portion of the circuit breaker 30 to be movable in the front-rear direction. In other words, the circuit breaker 30 may be supported by the transfer frame 21 and may move together with the transfer frame 21 in the front-rear direction.

Meanwhile, according to an embodiment of the present disclosure, a driven shaft 25 may be provided between the pair of guide frames 24, extending along a moving direction of the transfer frame 21, that is, the front-rear direction. In the present embodiment, the driven shaft 25 may be spaced apart below the transfer frame 21, as illustrated in FIG. 4.

The driven shaft 25 is configured to receive a driving force from a driving module 40, which will be described later, to move the transfer frame 21 and the circuit breaker 30.

For this purpose, in the present embodiment, a transfer member 22 coupled to the transfer frame 21 may be penetratively coupled to the driven shaft 25 to be movable in an axial direction. In addition, a thread may be formed on an outer circumferential portion of the driven shaft 25, and a corresponding thread may be formed on a portion of the transfer member 22 through which the driven shaft 25 is coupled.

In the present embodiment, the driven shaft 25 may be configured to receive a driving force from the driving module 40 and to be rotated by a driving shaft 58 coupled to its front end. For this purpose, a predetermined groove or protrusion that may be coupled to a rear end of the driving shaft 58 may be formed at a front end of the driven shaft 25.

Accordingly, when the driven shaft 25 rotates about its axis, the rotational motion of the driven shaft 25 may be converted into linear motion of the transfer member 22, and the transfer member 22 may move forward or backward along the axial direction.

In this case, according to the present embodiment, an upper portion of the transfer member 22 may protrude upward and be coupled to the transfer frame 21 so that the transfer frame 21 and the circuit breaker 30 may move together with the transfer member 22. Accordingly, when the driven shaft 25, which receives the driving force from the driving module 40, rotates, the transfer member 22, the transfer frame 21 coupled therewith, and the circuit breaker 30 may move together.

Meanwhile, referring again to FIGS. 3 and 4, in an embodiment of the present disclosure, the driven shaft 25 may be rotatably supported by the shaft frame 26 fixed to the lower wall of the cradle 10. As illustrated, according to an embodiment of the present disclosure, the shaft frame 26 may have a basket or bracket shape in which a space for accommodating the driven shaft 25 may be formed.

In this case, both ends in the extending direction of the driven shaft 25 disposed inside the shaft frame 26 may be rotatably supported by front and rear portions of the shaft frame 26, respectively. Accordingly, the driven shaft 25 may reliably convert the driving force generated by the driving module 40 into a force for moving the transfer frame 21 and the circuit breaker 30 in the front-rear direction.

Meanwhile, the structure of the transfer module 20 is not particularly limited as long as it is capable of moving the circuit breaker 30, and may be implemented in various known structures in addition to the above-described configuration. Furthermore, the relative positions of the transfer module 20 and the cradle 10 are not limited to the above description, and the transfer module 20 may be provided on another side of the cradle 10 depending on the structure or characteristics of the cradle 10 and the circuit breaker 30.

Referring to FIGS. 3 to 5, the driving module 40 and the distance measuring sensor 60 may be detachably coupled to an outer surface of the door 13 of the power apparatus 1 according to an embodiment of the present disclosure. In this case, the driving module 40 and the distance measuring sensor 60 may be referred to as a circuit breaker moving device 40 and 60 for the power apparatus.

The circuit breaker moving device 40 and 60 for the power apparatus according to an embodiment of the present disclosure may be provided as one of the configurations of the power apparatus 1 described above, or may be provided as a separate device to be used alternately in multiple power apparatuses 1.

The circuit breaker moving device 40 and 60 for the power apparatus according to an embodiment of the present disclosure may be configured to automatically move the circuit breaker 30 disposed inside the cradle 10. In addition, the circuit breaker moving device 40 and 60 for the power apparatus may be configured to accurately detect and control the position of the circuit breaker 30 inside the cradle 10.

Meanwhile, before describing the circuit breaker moving device 40 and 60 for the power apparatus according to an embodiment of the present disclosure, the window 13a and the shaft hole 13b of the door 13 described above will be explained.

Referring to FIG. 5, in an embodiment of the present disclosure, the window 13a and the shaft hole 13b may be formed in the door 13 as described above. More specifically, the window 13a may be formed as an opening positioned at a lower central portion of the door 13.

The window 13a is configured to allow the distance measuring sensor 60, which is disposed outside the cradle 10 to detect the position of the circuit breaker 30 in a non-contact manner, to view the circuit breaker 30 inside the cradle 10. In this case, a plate made of a material that allows signals emitted from the distance measuring sensor 60 toward the circuit breaker 30 to pass through may be installed in the window 13a. For example, a tempered glass plate may be installed in the window 13a.

Further, according to the present embodiment, the shaft hole 13b may be formed below the window 13a in the door 13. The driving shaft 58 of the driving module 40 may be disposed to pass through the shaft hole 13b. Accordingly, a rear end of the driving shaft 58 may be positioned inside the cradle 10. The rear end of the driving shaft 58 protruding into the cradle 10 may be coupled to a front end of the driven shaft 25 (illustrated in FIG. 4) disposed inside the cradle 10.

Meanwhile, referring to FIGS. 5 to 7, the driving module 40 of the circuit breaker moving device 40 and 60 for the power apparatus according to an embodiment of the present disclosure may include a support frame 42, a guide rod 52, an adjustment frame 54, an actuator 56, an actuator frame 57, and a driving shaft 58.

In this case, in the present embodiment, the support frame 42 may include a sensor support 43 configured to extend in the horizontal direction and to be disposed on an outer surface of the door 13. An arch-shaped module handle 44, which may be gripped by the worker, may be fixedly coupled to an upper surface of the sensor support 43. The worker may move the circuit breaker moving device 40 and 60 for the power apparatus using the module handle 44 or adjust its relative position with respect to the door 13.

In an embodiment of the present disclosure, the distance measuring sensor 60 may be disposed below the sensor support 43. The distance measuring sensor 60 may be configured to be supported by the sensor support 43. In addition, an upper portion of the distance measuring sensor 60 may be protected by the sensor support 43. Details of the distance measuring sensor 60 will be described below.

Meanwhile, according to an embodiment of the present disclosure, a first extension portion 45 and a second extension portion 47 may be provided on both sides of the sensor support 43, as illustrated. The first extension portion 45 and the second extension portion 47 may extend downward from the sensor support 43.

The first extension portion 45 and the second extension portion 47 may provide a base to which a first coupler 46 and a second coupler 48, which will be described below, are coupled. The first extension portion 45 and the second extension portion 47 may respectively protect both lateral sides of the distance measuring sensor 60. In addition, the first extension portion 45 and the second extension portion 47 may also serve to block external interference signals, enabling the distance measuring sensor 60 to more accurately detect the position of the circuit breaker.

According to the present embodiment, a first coupler 46 for detachably coupling the circuit breaker moving device 40 and 60 for the power apparatus to the door 13 may be provided on an outer surface of the first extension portion 45. In this case, the relative position between the first coupler 46 and the sensor support 43 may be appropriately adjusted as needed.

In this case, the first coupler 46 may be detachably coupled to the door 13 using magnetic force. More specifically, the first coupler 46 may include a hexahedral coupling body and a handle protruding forward from the coupling body and rotatable by an external force. A magnet may be provided inside the coupling body to move forward and backward in conjunction with the handle.

When the first coupler 46 is positioned adjacent to the outer surface of the door 13 and its handle is rotated in one direction, the magnet may move rearward. As a result, the first coupler 46 and the driving module 40 may be fixed to the door 13 by magnetic force generated as the magnet and the door 13 are positioned adjacent to each other.

Conversely, when the handle of the first coupler 46 is rotated in the opposite direction, the internal magnet may move forward. As a result, the magnet becomes spaced apart from the door 13, and the first coupler 46 and the circuit breaker moving device 40 and 60 for the power apparatus may be detached from the door 13.

Meanwhile, in addition to the above-described configuration, the first coupler 46 may also be implemented using various known coupling structures that allow the driving module 40 to be detachably coupled to the door 13, such as a bolt-nut structure or the like.

Meanwhile, in the present embodiment, a second coupler 48 may be provided on an outer surface of the second extension portion 47. The second coupler 48 may have the same configuration as the first coupler 46 described above, and thus a description thereof will be omitted by referring to the description of the first coupler 46.

Referring to FIGS. 5 to 7, in the power apparatus according to an embodiment of the present disclosure, a guide rod support 49 and a shaft support 50 may be provided in front of the first extension portion 45 and the second extension portion 47.

The guide rod support 49 is configured to support a guide rod 52, which will be described below. A front portion of the guide rod support 49 may extend forward to support a rear portion of the guide rod 52. A rear portion of the guide rod support 49 may be bent upward to be coupled to the first extension portion 45 and the second extension portion 47.

In the present embodiment, the shaft support 50 may be spaced apart from a lower side of the guide rod support 49.

A rear portion of the shaft support 50 may be bent downward to be coupled to the first extension portion 45 and the second extension portion 47. A front portion of the shaft support 50 may protrude downward. A connecting portion for linking the front portion and the rear portion may be provided between them. A hole through which a driving shaft 58, which will be described below, may pass may be formed in the protruding portion of the front portion of the shaft support 50.

Meanwhile, referring to FIGS. 6 and 7, in the present embodiment, a guide rod 52 may be provided in front of the support frame 42.

The guide rod 52 may be formed as a rod having a rectangular cross-section and extending forward from the support frame 42. However, the shape of the guide rod 52 is not limited to the above-described form. A rear portion of the guide rod 52 may be coupled to or supported by the guide rod support 49 of the support frame 42.

According to the present embodiment, as illustrated, two rows of fixing grooves 52a may be formed on an upper surface of the guide rod 52 along the extending direction. In addition, guide grooves 52b may be formed on both lateral surfaces of the guide rod 52 along the extending direction. In this case, both ends of each guide groove 52b in the extending direction may be open to the outside.

Meanwhile, referring to FIGS. 5 to 7, in an embodiment of the present disclosure, an adjustment frame 54 may be slidably coupled to the guide rod 52. The adjustment frame 54 is configured to adjust the position of an actuator 56, which will be described below. More specifically, the adjustment frame 54 may adjust the position of the actuator 56 in the extending direction of the guide rod 52, that is, in the front-rear direction.

The adjustment frame 54 may extend in the horizontal direction to cover a portion of an upper surface of the guide rod 52. Both sides of the adjustment frame 54 in the extending direction may be bent downward to cover portions of the lateral surfaces of the guide rod 52.

In this case, according to an embodiment of the present disclosure, a first guide protrusion 54a, which is slidably coupled to the guide groove 52b formed on the left surface of the guide rod 52, may protrude from a surface of the bent portion of the adjustment frame 54 facing the left surface of the guide rod 52. Likewise, a second guide protrusion 54b, which is slidably coupled to the guide groove 52b formed on the right surface of the guide rod 52, may protrude from a surface of the bent portion of the adjustment frame 54 facing the right surface of the guide rod 52.

The first guide protrusion 54a and the second guide protrusion 54b may be inserted into the guide grooves 52b of the guide rod 52 through their open ends. Accordingly, the adjustment frame 54 may be movably coupled to the guide rod 52. As the first guide protrusion 54a and the second guide protrusion 54b slide along the guide grooves 52b of the guide rod 52, the adjustment frame 54 may be moved in the extending direction of the guide rod 52.

According to an embodiment of the present disclosure, a plurality of holes may be formed in portions of the adjustment frame 54 that covers the upper surface of the guide rod 52, at positions corresponding to the fixing grooves 52a of the guide rod 52. A plurality of coupling members 55 may be inserted through the holes to be engaged with the fixing grooves 52a.

The coupling members 55 may penetrate the holes of the adjustment frame 54 downward and be inserted into the fixing grooves 52a of the guide rod 52, thereby fixing the relative positions of the adjustment frame 54 and the guide rod 52. Conversely, the coupling members 55 may penetrate the holes of the adjustment frame 54 upward and be withdrawn from the fixing grooves 52a of the guide rod 52, thereby releasing the positional fixation between the adjustment frame 54 and the guide rod 52.

Meanwhile, in the present embodiment, as illustrated, an actuator 56 may be provided on a lower side of the adjustment frame 54. In this case, the actuator 56 may be implemented using an electric motor, for example.

And an actuator frame 57 may be provided between the adjustment frame 54 and the actuator 56 to fixedly couple the actuator 56 to the adjustment frame 54. The actuator frame 57 may be coupled to the adjustment frame 54 using a bolt-nut or the like, thereby fixing the actuator 56 to the adjustment frame 54.

As described above, according to the present embodiment, the adjustment frame 54 may move along the extending direction of the guide rod 52, thereby allowing the front-rear position of the actuator 56 to be appropriately adjusted. Once the front-rear position of the actuator 56 is adjusted, the adjustment frame 54 may be fixed to the guide rod 52 by the coupling members 55, thereby fixing the actuator 56 in the front-rear direction.

Through this, the distance by which the actuator 56 is spaced apart from the door 13 of the cradle 10 may be adjusted. Accordingly, the actuator 56 and the driving shaft 58, which will be described later, may have their positions appropriately adjusted to match the structure of the cradle 10 and the transfer module 20 provided inside the cradle 10.

Referring to FIGS. 5 to 7, in the present embodiment, a driving shaft 58 may be installed at a rear portion of the actuator 56. The driving shaft 58 may extend rearward from the actuator 56. Further, the driving shaft 58 may be configured to rotate by a driving force generated by the actuator 56.

In this case, an intermediate portion of the driving shaft 58 in the front-rear direction may be disposed within and supported by the hole formed in the shaft support 50 described above. In addition, a corresponding protrusion or groove may be formed at an end of the driving shaft 58 to be coupled to the front end of the driven shaft 25 (illustrated in FIG. 4).

Accordingly, the driving force generated by the actuator 56 may be transmitted to the transfer frame 21 (illustrated in FIG. 4) and the circuit breaker 30 through the driving shaft 58 and the driven shaft 25 (illustrated in FIG. 4), thereby allowing the circuit breaker 30 to be automatically moved.

Referring again to FIGS. 3 and 5, a distance measuring sensor 60 configured to measure a distance to the circuit breaker 30 in a non-contact manner may be supported on the sensor support 43 of the driving module 40 of the circuit breaker moving device 40 and 60 for the power apparatus according to an embodiment of the present disclosure.

In this case, in the present embodiment, the distance measuring sensor 60 may be spaced apart in front of the circuit breaker 30. More specifically, the distance measuring sensor 60 may be disposed on an outer surface of the door 13 and may be positioned to view the circuit breaker 30 through a window 13a of the door 13. To this end, the position at which the circuit breaker moving device 40 and 60 for the power apparatus is coupled to the outer surface of the door 13 may be appropriately adjusted.

In this case, in the present embodiment, the distance measuring sensor 60 may be implemented as a laser distance sensor configured to measure a distance to the circuit breaker 30 by emitting a laser toward the circuit breaker. However, the distance measuring sensor 60 is not particularly limited as long as it is configured to be spaced apart from the circuit breaker and to measure the distance thereto in a non-contact manner.

According to an embodiment of the present disclosure, the distance measuring sensor 60 may be configured to be electrically connected to the controller. The controller may be implemented using circuitry processed by hardware, or may be implemented by a processor, a central processing unit (CPU), a controller, an arithmetic logic unit (ALU), a digital signal processor (DSP), a microcomputer, a field-programmable gate array (FPGA), a system on a chip (SoC), a programmable logic unit, a microprocessor, or any device capable of performing the functions described below.

In the present embodiment, the controller may be configured to detect a position of the circuit breaker 30 based on the information acquired by the distance measuring sensor 60. The controller may also be configured to control the actuator 56 based on the detected position of the circuit breaker 30. Through this, the controller may control the position of the circuit breaker 30.

As described above, according to the present embodiment, the distance measuring sensor 60 may measure a distance to the circuit breaker 30 in a non-contact manner, and the controller may detect a position of the circuit breaker 30 based on the measured distance, so that the position of the circuit breaker 30 moving inside the cradle 10 may be accurately detected.

In addition, according to the present embodiment, since the distance measuring sensor 60 may measure a distance to the circuit breaker 30 in a non-contact manner, there is no need to separately provide a contact-type switch for detecting the position of the circuit breaker 30 inside the power apparatus, thereby increasing the design flexibility, space utilization, and durability of the power apparatus.

Further, according to the present embodiment, the controller may detect the position of the circuit breaker 30 based on the information acquired by the distance measuring sensor 60 and control the actuator 56 based on the detected position, so that the position of the circuit breaker 30 may be accurately controlled, for example, by precisely moving the circuit breaker 30 to a desired position.

Hereinafter, a process in which the distance measuring sensor and the controller of the power apparatus according to an embodiment of the present disclosure accurately control the position of the circuit breaker will be briefly described.

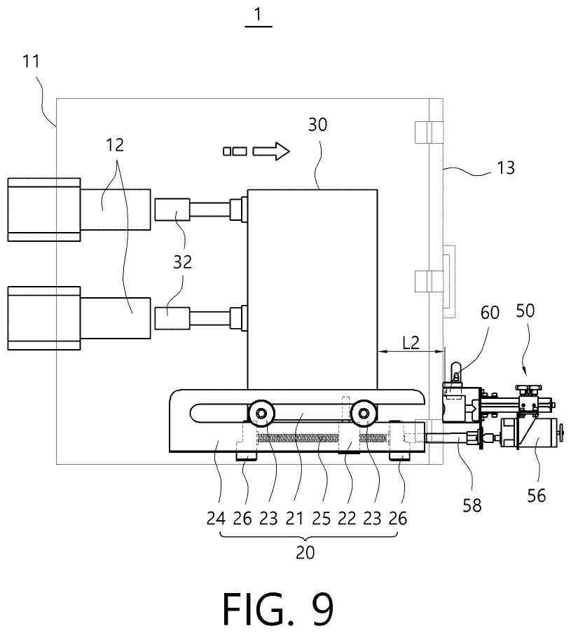

FIG. 8 is a view illustrating a state in which the circuit breaker of the power apparatus according to an embodiment of the present disclosure is positioned at a connection position. In this case, the configurations that are visually perceivable through the cradle are indicated by solid lines, and the driven shaft, the transfer member, and the distance measuring sensor are indicated by dotted lines. FIG. 9 is a view illustrating a state in which the circuit breaker of the power apparatus according to an embodiment of the present disclosure moves from the connection position to a separation position. In this case, the configurations that are visually perceivable through the cradle are indicated by solid lines, and the driven shaft, the transfer member, and the distance measuring sensor are indicated by dotted lines. FIG. 10 is a view illustrating a state in which the circuit breaker of the power apparatus according to an embodiment of the present disclosure is positioned at a separation position. In this case, the configurations that are visually perceivable through the cradle are indicated by solid lines, and the driven shaft, the transfer member, and the distance measuring sensor are indicated by dotted lines.

The distance measuring sensor and the controller of the power apparatus according to an embodiment of the present disclosure may control the circuit breaker to move from an initial position to a target position. In this case, the target position may be set to an arbitrary position located along a movable path of the circuit breaker.

Hereinafter, as an example of controlling the position of the circuit breaker by the distance measuring sensor and the controller according to the present embodiment, a process will be described in which the circuit breaker is controlled to move from a connection position as an initial position to a separation position as a target position.

Referring to FIG. 8, the circuit breaker 30 may be positioned at the connection position to perform its original function. In this case, to control the position of the circuit breaker 30 (that is, to move the circuit breaker 30), the circuit breaker moving device 40 and 60 for the power apparatus according to an embodiment of the present disclosure may be coupled to the door 13 of the cradle 10. Accordingly, the driving shaft 58 and the driven shaft 25 may be coupled to each other so as to be capable of transmitting power.

In this case, the distance measuring sensor 60 may measure a distance LI from the circuit breaker 30. The controller may detect a position of the circuit breaker 30 inside the cradle 10 based on the measured distance L1.

Referring to FIGS. 8 and 9, the controller may control the actuator 56 such that the driving shaft 58 is rotated in one direction. Accordingly, the driven shaft 25 coupled to the driving shaft 58 may be rotated in the same direction, and the transfer member 22 coupled to the driven shaft 25 may be moved forward.

As the transfer member 22 is moved forward, the transfer frame 21 coupled to the transfer member 22 and the circuit breaker 30 supported by the transfer frame 21 may be moved forward together.

Referring to FIG. 9, as the circuit breaker 30 is moved forward, the distance L2 between the distance measuring sensor 60 and the circuit breaker 30 may be reduced. In this case, the distance measuring sensor 60 may continuously measure the distance to the circuit breaker 30, and the controller may be configured to continuously detect the position of the circuit breaker 30.

Referring to FIG. 10, as the circuit breaker 30 is moved forward, the circuit breaker 30 may reach a desired separation position. In this case, the distance measuring sensor 60 may be configured to continuously measure the distance L3 to the circuit breaker 30.

When the distance L3 to the circuit breaker 30 measured by the distance measuring sensor 60 is equal to a preset distance corresponding to the circuit breaker 30 positioned at the separation position, the controller may determine that the circuit breaker 30 is located at the separation position. If it is determined that the circuit breaker 30 is located at the separation position, the controller may control the actuator 56 to stop. Accordingly, the circuit breaker 30 may be accurately positioned at the separation position. In other words, the position of the circuit breaker 30 may be precisely controlled.

Meanwhile, according to an embodiment of the present disclosure, the process of moving the circuit breaker 30 from the separation position to the connection position may be performed by setting the separation position as an initial position and the connection position as a target position.

As described above, the power apparatus 1 according to the present embodiment may accurately detect the position of the circuit breaker 30 inside the cradle 10 by allowing the distance measuring sensor 60 to accurately measure a distance to the circuit breaker 30 in a non-contact manner and allowing the controller to detect the position of the circuit breaker 30 based on the measured distance.

In addition, the power apparatus 1 according to the present embodiment may accurately control the position of the circuit breaker 30 by controlling the actuator 56 based on the position information of the circuit breaker 30 accurately detected by the controller.

Further, since the power apparatus 1 according to the present embodiment does not need to include a separate switch for detecting the position of the circuit breaker 30, the design flexibility and space utilization of the power apparatus may be increased, and durability may be improved by eliminating the possibility of damage caused by physical contact.

Meanwhile, in the present embodiment, although the distance measuring sensor is configured to detect the position of the circuit breaker by measuring a distance to the circuit breaker, it may alternatively be configured to indirectly detect the position of the circuit breaker by measuring a distance to a configuration other than the circuit breaker. For example, the distance measuring sensor may be configured to indirectly measure the distance to the circuit breaker by measuring a distance to the transfer frame.

In the present embodiment, the distance measuring sensor is configured to be disposed outside the cradle. However, the position of the distance measuring sensor is not particularly limited as long as it can view the circuit breaker to measure a distance spaced apart therefrom. For example, the distance measuring sensor may be installed on an inner wall of the cradle.

Although exemplary embodiments of the present disclosure have been described above, the scope of the present disclosure is not limited to the embodiments set forth herein. Those skilled in the art who understand the spirit of the present disclosure may readily propose other embodiments by adding, modifying, deleting, or supplementing components within the scope of the present disclosure, and such embodiments should also be regarded as falling within the scope of the present disclosure.
1: power apparatus 10: cradle
20: transfer module 30: circuit breaker
40: driving module 60: distance measuring sensor

1. A device for moving a circuit breaker for a power apparatus, comprising:
an actuator configured to generate a driving force for moving a circuit breaker disposed inside a cradle of a power apparatus;
a support frame configured to support the actuator and to be detachably coupled to an outer portion of the cradle;
a distance measuring sensor provided on one side of the support frame and configured to measure a distance to the circuit breaker; and
a controller configured to control the actuator based on information acquired by the distance measuring sensor.

2. The device of claim 1, wherein the support frame includes:
a sensor support configured to support the distance measuring sensor;
an extension portion configured to extend from the sensor support to protect one side of the distance measuring sensor; and
a coupler provided on one side of the extension portion and configured to detachably couple the support frame to an outer side of the cradle.

3. The device of claim 1, comprising:
a guide rod configured to extend outward from the support frame; and
an adjustment frame configured to be movably coupled to the guide rod, the actuator being fixedly coupled to the adjustment frame.

4. The power apparatus of claim 3, wherein the adjustment frame is provided with a coupling member configured to fix or release a relative position between the adjustment frame and the guide rod.

5. The power apparatus of claim 3, wherein a guide groove is formed along an extending direction on an outer circumferential portion of the guide rod, and
one side of the adjustment frame is slidably inserted into the guide groove.

6. The device of claim 1, wherein the actuator is provided with a driving shaft, the driving shaft being extended outward from one side of the actuator to transmit the driving force into the cradle.

7. The device of claim 6, wherein a hole is formed in the support frame, and one side of the driving shaft is inserted into the hole formed in the support frame so as to be rotatably supported by the support frame.

8. The power apparatus of claim 1, wherein the support frame includes:
a sensor support having the distance measuring sensor supported on one side thereof;
a first extension portion configured to obliquely extend from one side of the sensor support to protect one side of the distance measuring sensor; and
a second extension portion configured to obliquely extend from the other side of the sensor support to protect the other side of the distance measuring sensor.

9. The power apparatus according to claim 1, wherein the distance measuring sensor is a laser distance sensor configured to measure a distance using a laser emitted toward the circuit breaker.

10. A power apparatus comprising:
a cradle configured to have a housing shape and to include a cradle terminal on an inner wall thereof;
a transfer frame movably provided on one side of the cradle;
a circuit breaker supported by the transfer frame and configured to be moved to a connection position where the circuit breaker is mechanically and electrically connected to the cradle terminal or to a separation position where the circuit breaker is separated from the cradle terminal;
an actuator configured to provide a driving force for moving the transfer frame such that the circuit breaker is moved to the connection position or the separation position;
a distance measuring sensor disposed apart from the circuit breaker and configured to measure a distance to the circuit breaker; and
a controller configured to control the actuator based on information acquired by the distance measuring sensor.

11. The power apparatus of claim 10, wherein the distance measuring sensor is disposed to face the cradle terminal with the circuit breaker interposed therebetween.

12. The power apparatus of claim 11, wherein the cradle includes a first side wall on which the cradle terminal is installed and a second side wall facing the first side wall,
wherein the distance measuring sensor is disposed outside the second side wall, and
wherein the second side wall of the cradle is provided with a window configured to allow the distance measuring sensor to view the circuit breaker disposed inside the cradle.

13. The power apparatus of claim 12, comprising:
a support frame provided on an outer surface of the second side wall,
wherein the actuator is coupled to one side of the support frame, and
wherein the distance measuring sensor is installed on the other side of the support frame.

14. The power apparatus of claim 13, comprising:
a driven shaft disposed adjacent to one surface of the transfer frame to move the transfer frame as it rotates by an external force; and
a driving shaft having one side coupled to the driven shaft and the other side configured to receive the driving force generated by the actuator,
the driving shaft penetrating the outer surface of the cradle.

15. The power apparatus of claim 13, wherein the support frame is detachably coupled to the outer surface of the second side wall.

16. The power apparatus of claim 13, comprising:
a guide rod configured to extend from the support frame in a direction away from the cradle; and
an adjustment frame configured to be slidably coupled to the guide rod,
wherein the actuator is coupled to the adjustment frame such that a distance spaced apart from the cradle may be adjusted.

17. The power apparatus of claim 16, wherein the adjustment frame is provided with a coupling member configured to fix or release a relative position between the adjustment frame and the guide rod.

18. The power apparatus of claim 16, wherein a guide groove is formed along an extending direction on an outer circumferential portion of the guide rod, and
one side of the adjustment frame is slidably inserted into the guide groove.

19. The power apparatus of claim 10, wherein one side wall of the cradle is formed as a door that is openable and closable to allow the circuit breaker to enter and exit.

20. The power apparatus of claim 19, wherein the distance measuring sensor is disposed on one surface of the door.

21. The power apparatus of claim 10, wherein the distance measuring sensor is disposed to be spaced apart from the circuit breaker in a direction parallel to a moving direction of the circuit breaker.

22. The power apparatus of claim 10, wherein the distance measuring sensor is a laser distance sensor configured to measure a distance using a laser emitted toward the circuit breaker.
